(19) United States
(12) Patent Application Publication
(10) Pub. No.: US 2014/0292255 A1
(43) Pub. Date: Oct. 2, 2014

(54) USB CHARGING STRUCTURE OF MOBILE POWER PACK

(71) Applicant: Hsiao-Chiang Chu, Taipei (TW)

(72) Inventor: Hsiao-Chiang Chu, Taipei (TW)

(21) Appl. No.: 14/053,795

(22) Filed: Oct. 15, 2013

(30) Foreign Application Priority Data
Apr. 2, 2013 (TW) 102206085

(51) Int. Cl. H02J 7/00

(52) U.S. Cl. CPC H02J 7/0052
USPC 320/107

(57) ABSTRACT

A USB charging structure of mobile power pack is provided, which includes a mobile power body and a USB plug. The mobile power body includes a rechargeable battery, and the USB plug is disposed within an accommodate space of the mobile power body, which is electrically connected with the rechargeable battery or the device is electrically connected with the rechargeable battery. With the design of the outlet that is communicated with the accommodate space, the USB plug can be pushed outward from or drawn back into the mobile power body, such that when the mobile power is to be charged or is to be performed the data transmission with the device, the USB plug can be pushed outward from the mobile power body to perform charge or data transmission in the device with a USB infrastructure.

### FIELD OF THE INVENTION

The present invention relates to a USB charging structure of mobile power pack, and in particular to a mobile power pack that has a built-in USB plug configured for pushed out or drawn into the mobile power pack, which is able to charge a cellular phone, or enable a data synchronous transmission between the cellular phone and a electronic device, via the protruded USB plug.

### BACKGROUND

The conventional mobile power pack such as Taiwan Patent Application No. 101216355 tilted “mobile power pack with multiple functions”, which discloses a body unit, an energy storage unit, a supporter and a holder. The height between the top surface and the bottom surface is larger than the width between two sides of the body unit and is also larger than the thickness between a front side and a rear side of the body unit. The supporter can be operated from the collapsed status into the support status with respect to the body unit. The holder can be operated from the fold status into unfold status, so as to the good support, common use and multifunction usage can be achieved.

Although the above mentioned mobile power pack includes the advantages, such as good support, common use, and multifunction usage, the disadvantage of such conventional mobile power is that the mobile power is connected with the rechargeable device via the adapter cable to perform the recharge process, that is, the adapter cable is prepared before the device is to be charged, unfortunately, the device cannot be connected with the rechargeable device to be charged when the adapter cable is lost.

Accordingly, the conventional mobile power pack still has some drawbacks, and some improvements are needed.

### SOME EXEMPLARY EMBODIMENTS

These and other needs are addressed by the present invention, wherein an approach is provided for a mobile power pack that has a built-in USB plug, which improves above mentioned drawbacks of the conventional mobile power pack.

An objective of the present invention is to provide a USB charging structure of mobile power pack, in which an additional adapter cable is not required to be prepared before charging a device. It makes easy for a person to achieve purposes of recharge and data transmission at any time.

Another objective of the present invention is to provide a USB charging structure of mobile power pack, in which the data transmission is performed by using a USB plug between a cellular phone and a device.

Yet another objective of the present invention is to provide a USB charging structure of mobile power pack, which is integrated with a USB plug that can be pushed outward from or drawn back into the mobile power pack. The recharge or data transmission can be performed by using the protruded USB plug of the mobile power.

According to above objectives, an aspect of an embodiment of the present invention provided with a USB charging structure of a mobile power pack comprises a mobile power body and a USB plug. The mobile power body has a rechargeable battery and an accommodate space. The accommodate space is formed in the mobile power body. One side of the mobile power body has an outlet which is communicated with the accommodate space. The USB plug is disposed within the accommodate space of the mobile power body, and is electrically connected to the rechargeable battery, or between an electronic device and the rechargeable battery. the rechargeable battery of the mobile power body is to be charged from the device with a USB infrastructure, and the mobile power pack performs a data synchronous transmission between a cellular phone and the device, whereby the USB plug is selectively pushed outward from or drawn back into the accommodate space of the mobile power body as the outlet is communicated with the accommodate space.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a schematic view showing a mobile power in accordance with the present invention;

FIG. 2 is a schematic view showing a using of mobile power in accordance with the present invention;

FIG. 3 is a another schematic view showing a mobile power in accordance with the present invention; and

FIG. 4 is another schematic view showing using of a mobile power in accordance with the present invention.

### DESCRIPTION OF THE PREFERRED EMBODIMENT

A USB charging structure of mobile power pack is disclosed. In the following description, for the purposes of explanation, numerous specific details are set forth in order to provide a thorough understanding of the present invention. It is apparent, however, to one skilled in the art that the invention may be practiced without specific details or with an equivalent arrangement. In other instances, well-known structures and devices are shown in block diagram form in order to avoid unnecessarily obscuring the embodiments of the present invention.

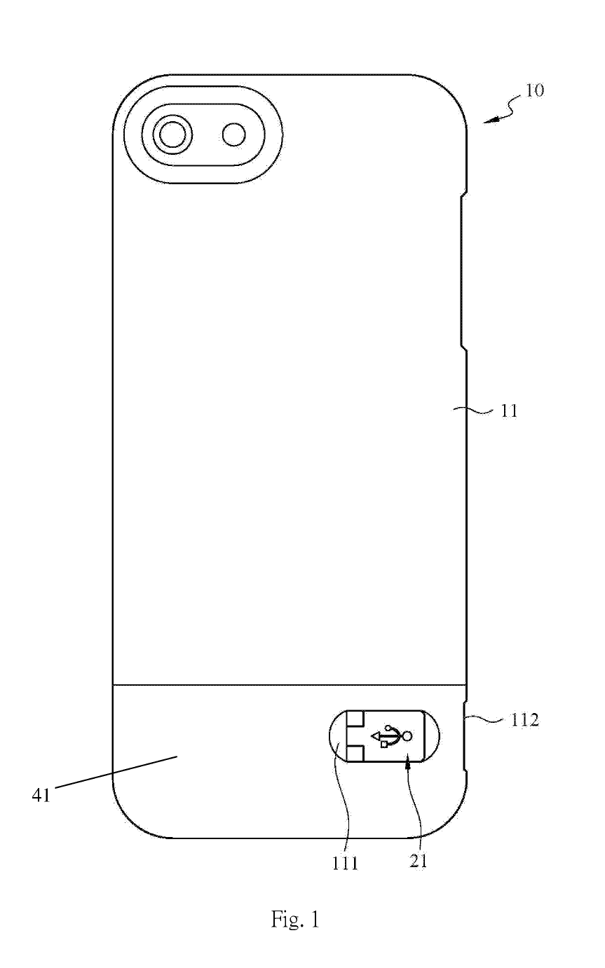

With reference to the drawings and in particular to FIGS. 1-3, a structure of USB charging structure of a mobile power pack is shown, which includes a mobile power body 10 and a USB plug 21.

The mobile power body 10 includes a hollow outer shell 11, and the hollow outer shell 11 includes a rechargeable battery (not shown). The hollow outer shell 11 includes an accommodate space 41 and an outlet 112. The accommodate space 41 is formed inside the hollow outer shell 11. The outlet 112 is disposed on one side of the hollow outer shell 11 and is communicated with the accommodate space 111.

The USB plug 21 is disposed in the accommodate space of the mobile power body 10, and is electrically connected with the rechargeable battery (not shown). An external device with a USB infrastructure can charge the rechargeable battery (not shown) and perform a data synchronous transmission between a cellular phone and the device. In addition, with the design of the outlet 112 is communicated with the accommodate space 41, the USB plug 21 can be pushed outward from the mobile power body 10, or drawn back into the accommodate space 41 of the mobile power body 10.

Accordingly, when the mobile power body 10 is to be charged and the data transmission is performed between the cellular phone and the device with the USB infrastructure (not shown), the USB plug 21 can be pushed outward from the mobile power body 10. Therefore by making the USB plug 21 protruded outwardly, the recharge or the data transmission can be performed at any time to a device with the USB infrastructure (not shown) and the no other adapter cable needs to prepare to be the transmission medium for charging or data transmission.

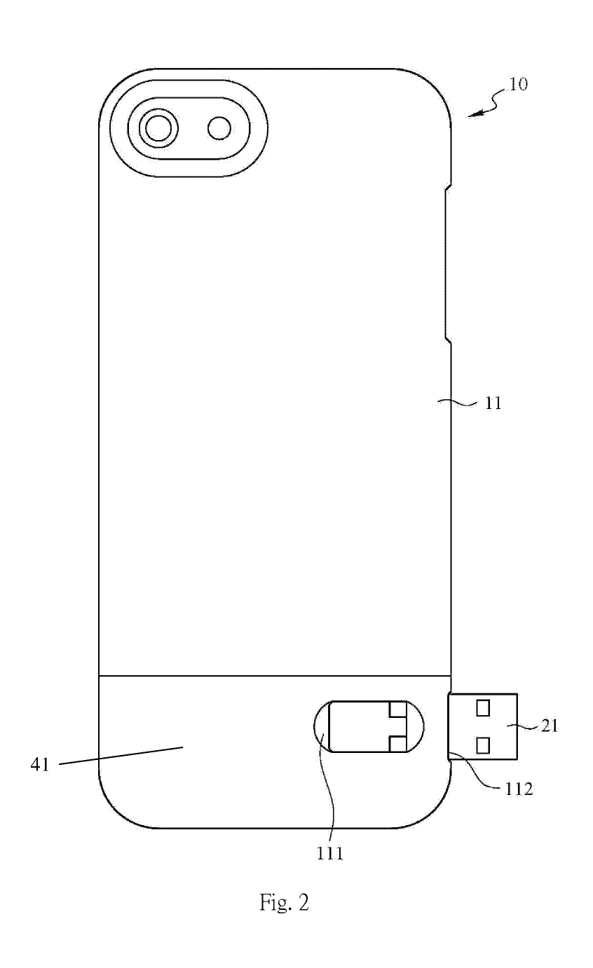

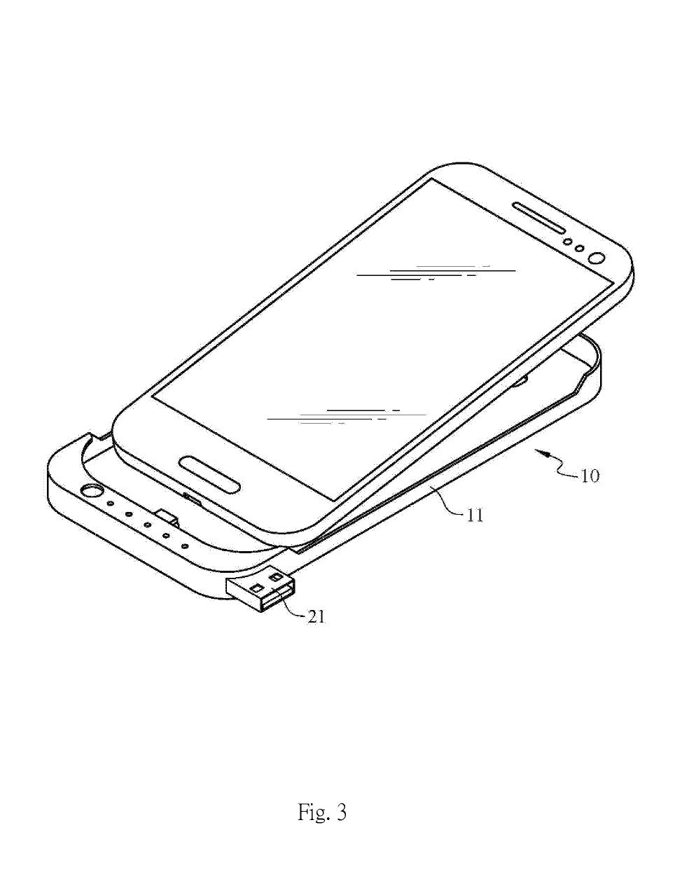

With reference to FIG. 1, FIG. 2 and FIG. 3, the rechargeable battery (not shown), in an embodiment, is a lithium battery.

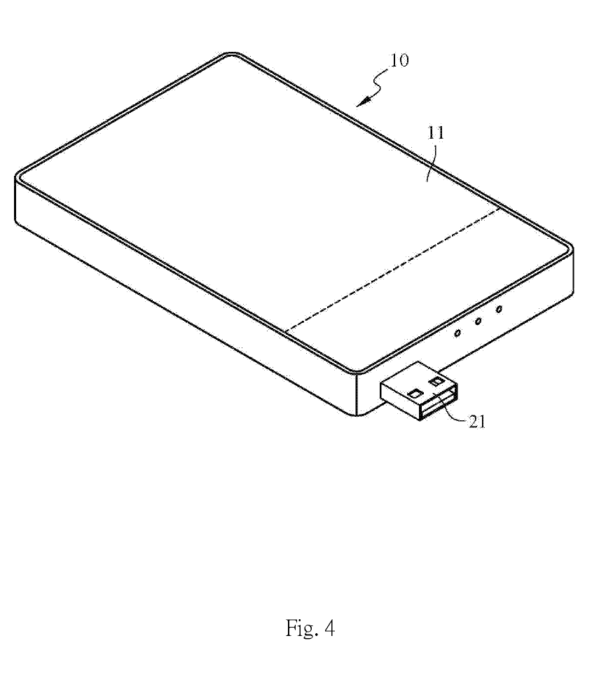

Please refer to FIG. 4. FIG. 4 is another embodiment of the present invention. The mobile power body 10 includes a hollow outer shell 11. The hollow outer shell 11 includes a rechargeable battery (not shown) and an accommodate slot 111 disposed on the hollow outer shell 11.

The USB plug 21 is disposed on the accommodate slot 41 and is electrically connected with the rechargeable battery (not shown). An external device with a USB infrastructure can charge the rechargeable battery and perform a data synchronous transmission between the cellular phone and the device.

To compare the conventional mobile power, the advantages of the USB charging structure of mobile power pack in accordance with the present invention, includes:
1. For recharge, no other adapter cable needs to prepare, and thus, the charging can be performed at any time;
2. When the data transmission is performed between the cellular phone and the device with the USB infrastructure, no other adapter cable needs to prepare, and thus, the data transmission can be performed at any time; and
3. The USB plug can be pushed outward from or drawn into the mobile power body, such that the USB plug can be used for recharging or data transmission.

According to above discussions, the USB charging structure of mobile power is a new invention and is not shown in any publications, and there is no similar product is the market. Thus, this invention is a novel invention.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A USB charging structure of a mobile power pack, comprising:
a mobile power body having
a rechargeable battery; and
an accommodate space being formed in said mobile power body, wherein one side of said mobile power body has an outlet which is communicated with said accommodate space; and
a USB plug being disposed within said accommodate space of said mobile power body, and being electrically connected to said rechargeable battery or between an electronic device and said rechargeable battery, wherein said rechargeable battery of said mobile power body is to be charged from the device with a USB infrastructure, and said mobile power pack performs a data synchronous transmission between a cellular phone and said device, whereby said USB plug is selectively pushed outward from or drawn back into said accommodate space of said mobile power body as said outlet being communicated with said accommodate space.

2. The USB charging structure according to claim 1 wherein said rechargeable battery is Lithium battery.
